(19) United States
(12) Patent Application Publication
(10) Pub. No.: US 2012/0073324 A1
(43) Pub. Date: Mar. 29, 2012

(54) "TENNIS" TYPE WEARABLE JEWEL AND PROCESS FOR PRODUCING SUCH A WEARABLE JEWEL

(75) Inventor: Michele Bovo, Trissino (VI) (IT)

(73) Assignee: FRATELLI BOVO S.R.L, Trissino (VI) (IT)

(21) Appl. No.: 13/187,347

(22) Filed: Jul. 20, 2011

(30) Foreign Application Priority Data
Jul. 23, 2010 (IT) VI2010A000204

(51) Int. Cl. A44C 5/02; B23P 5/00

(52) U.S. Cl. 63/3; 29/10

(57) ABSTRACT

A “Tennis” type wearable jewel (1) comprising a base piece (2) made of metallic material and composed of a plurality of shaped bezels (3), each of which presents a housing seat (4) facing outwards, and a plurality of ornamental elements (5) remaining in sight, each of which firmly coupled with retention means (6) with one of the shaped bezels (3) at the related housing seat (4). In particular, at least one of the ornamental elements comprises a laminar plate (7) made of metallic material, covering at least partially the housing seat (4) of at least one of the shaped bezels (3).

The present invention relates to a wearable necklace of goldsmith, jewellery and/or trinkets, such as a bracelet, necklace, chain, anklet, ring, earring or other similar ornamental handiwork of the so-called “tennis” type.

The present invention relates also to a process for producing of a wearable jewel of “tennis” type.

As known, the ornamental goldsmith, jewellery and/or similar jewels which can be worn by people are currently produced according to several styles, colours, combinations and, more generally, according to numerous aesthetic effects.

These ornamental jewels generally include jewellery pieces or components typically made of metallic alloy of precious material, such as silver or gold in their possible colours and finenesses, to which further embellishment elements such as natural stones, whether precious (gems), simply semiprecious and/or synthetic ones (e.g. zircon), are often combined, for example by setting.

Operators of goldsmith sector have been dealing by this time for a few years with trends more and more particular and opposing each other, also dictated by the unfavorable economic conjectural situation in which, as known, the sector finds itself.

Customers, indeed, on one hand, require that the jewel or gem is equipped with a highly distinctive gradient, able to give rise in the person who wears it emotional values and exclusivity feelings highly greater than other ornamental or precious handiworks which can be purchased on the market.

This implies the constant search for new models to be proposed to the market and, consequently, production flexibility and new investments in material and equipment by the manufacturers.

On the other hand, at the same time, customers require that the jewels have a limited sale price, requirement that, contrary to what just said, obliges the manufacturer to seek to somehow limit the production cost, target which is certainly not reachable with the only reduction in the labour cost as a whole.

Also jewels marked with a metallic material, usually precious, mould base, consisting of a plurality of shaped bezels, one side by side and consecutive each other, which house by setting a plurality of as many stones, usually diamonds, do not get out of the aforesaid logic dictated by the market.

Just the jewels (especially bracelets, necklaces or chains) having the particular constructive composition just described, better known in goldsmith field as “tennis” jewels, concern the present invention.

Jewels of “tennis” type of the prior art have recently taken rather sophisticated and complex constructive shapes that determine for the final product original and qualified aesthetic connotations with respect to the traditional solutions known by this time for decades, able to meet the new needs of customers ensuring, at the same time, the producer a level of differentiation and recognition in the market useful to achieve competitive advantages.

However, for “tennis” jewels some limitations of technical type still persist, mainly determined by the fact that a very specific kind of base piece implies some constraints in terms of types and shapes of stones to be applied restricting and crystallizing the aesthetic effects which can be obtained.

Indeed, in the commercially available “tennis” jewels a given base piece, marked by a certain shape of the housing seat of the bezels, is suitable to receive, as stated in general by setting, one and only one well defined constructive type of stone.

In case it is desired to change the shape of stone to be set in the housing seat of the various bezels with respect to a jewel model already produced and marketed, thus obtaining a different aesthetic effect, it is necessary to produce (by moulding, casting or turning) a new and special base piece.

Such an aspect clearly involves the duplication of semi-finished products and code articles, to which an increase in production costs (especially if the semi-finished products are produced by moulding) and management is accompanied, the other parameters involved in then calculation being equal factors.

A second limitation of the prior art in question is due to the fact that, as wide variety of stones applied or applicable to the bezels of the base piece is, the aesthetic effect of the “tennis” jewel is fixed, in some ways monotonous and repetitive being always connected with the setting of stones (precious and semiprecious stones, hard and/or synthetic).

A further limitation of the wearable jewels of “tennis” type today available on the market is closely linked to the percentage of recovery of raw material when, due to lack of sales reasons, the seller decides to dismantle or disassemble the jewel itself.

In this regard, it is stressed that the recovery of raw material obtained from a wearable jewel is a factor that heavily weighs upon the evaluations of the sector wholesalers who buy jewels on the basis of their weight.

In case the wearable jewels of “tennis” type include synthetic, or in any case non-precious, stones, indeed, such a percentage of recovery does not result optimal since the owner of the jewel loses the weight share associated with the non-precious stones that are inevitably rejected and disposed, retaining only the portion relating to the base piece which is refined and recast instead.

Furthermore, it has not to be forgotten that, for a well defined constructive version of wearable jewel of “tennis” type expressly comprising precious stones, the producer can currently modify, in the sense of reducing, the preciousness of the jewel itself (the so-called “weighing into carats”) only by changing constructive version of the jewel, passing to a jewel marked by smaller bezels or other type of stone, with the obvious disadvantages that derive from it.

A last but not least limitation of the prior art in exam derives from the fact that the processes now used to produce wearable jewels of “tennis” type have always been designed so as to provide only stones as superficial or ornamental elements or at sight.

The present invention intends to overcome the limitations of the prior art set out above.

In particular, main purpose of the present invention is to provide a “tennis” type wearable jewel which compared to the equivalent known art allows to extend the range of aesthetic effects that can be achieved with a single and well-defined base piece made of metallic material.

In other words, primary purpose of the invention is to create a “tennis” type wearable jewel whose flexible base piece made of metallic material, contrary to the known art, is able to effectively receive ornamental elements which differ each other for profile, shape, surface finishing, material and/or type.

It is therefore main purpose of the invention to design a “tennis” type wearable jewel which allows to vary its own aesthetic effect without the need to replace the flexible base piece made of metallic material but simply the type of ornamental element applied at the housing seat of one or more of the shaped bezels of the base piece itself.

Within this purpose, it is task of the invention to give substance to a “tennis” type wearable jewel which allows, compared to the state of the art, to simplify the procedures of production and semi-finished products inventory management when it is desired to change the aesthetic effect combined to it.

It is another task of the present invention to develop a “tennis” type wearable jewel which with respect to the known prior art allows to reduce on the whole production and management costs.

It is a second purpose of the present invention to make available a “tennis” type wearable jewel which livens up the aesthetic effect typical of the equivalent jewels of known type, in particular, releasing it from the traditional one of stones.

It is another purpose of the invention to provide a “tennis” type wearable jewel which, especially when it includes non-precious stones as ornamental elements, allows to recover a percentage of raw materials higher than similar known jewels.

It is a further purpose of the invention described herein to indicate a “tennis” type wearable jewel which allows to simplify and make more flexible the activities that the manufacturer has to implement in order to modify, or better, reduce the weighing into carats of a given constructive version of the jewel itself.

It is a last but not least purpose of the invention to implement a process which allows to effectively produce a “tennis” type wearable jewel using ornamental elements which differ from those ones typically used today, namely stones, while however keeping a high aesthetic pleasantness and high originality gradient. The aforesaid purposes are firstly achieved by a “tennis” type wearable jewel according to the attached claim 1, as hereinafter referred for the sake of brevity.

Further constructive features of detail of the wearable jewel of the invention are set forth in the corresponding dependent claims.

The abovementioned purposes are also achieved by a process for producing a “tennis” type wearable jewel, integral part of the present invention, according to enclosed claim 9, as hereinafter referred for the sake of brevity as well.

Advantageously, the “tennis” type wearable jewel of the invention allows to extend with respect to the known art the range of aesthetic effects which can be achieved with a single flexible base piece made of generally precious metallic material.

This thanks to the fact that one or more of the ornamental elements belonging to the “tennis” type wearable jewel of the invention includes a laminar plate made of metallic material, which can be produced according to various shapes effectively applicable to the housing seat of the shaped bezels of a single base piece.

Unlike what happens for the equivalent jewels of known type, the “tennis” type wearable jewel of the invention includes a base piece suitable to effectively receive, in the same constructive version, ornamental elements that are different each other in respect of shape, surface finishing, profile, material and/or type.

After all, then, in the invention it is possible to manufacture with a single flexible base piece a plurality of “tennis” type wearable jewel having aesthetic effects different each other.

Still advantageously, the wearable jewel of the present invention simplifies, compared to prior art, the production activities and semi-finished products inventory management procedures to be implemented in order to get a plurality of jewels of the aforesaid type with aesthetic effects which differ one from another.

In this way, equally advantageously, the invention allows to reduce as a whole production and management costs of precious items such as “tennis” type wearable jewels.

In advantageous manner, moreover, the “tennis” type wearable jewel presents an aesthetic effect radically renewed with respect to the equivalent wearable jewels of conventional type.

The wearable jewel of the invention also allows, advantageously, to recover a percentage of raw materials, constituted specifically by the, generally precious, metallic material of the laminar plate, greater than equivalent jewels of known type, including non-precious stones as ornamental elements.

Advantageously, moreover, the “tennis” type wearable jewel of the present invention simplifies and makes more flexible the activities that the manufacturer must carry out to reduce the weighing into carats of a given constructive version of the jewel itself, owing to the application of one or more laminar plates instead of one or more of respective precious stones in the base piece itself.

In advantageous way, the process of the invention allows also to produce “tennis” type wearable jewel including ornamental elements which differ from stones, typical of similar jewels of known type, thanks to the fact of being able to effectively and accurately apply a laminar plate in the housing seat of one or more of the shaped bezels of the base piece of the jewel itself.

Such a constructive trick represents a kind of revolution in the production of jewels of “tennis” type, always meant and exclusively designed with precious, semiprecious, hard or synthetic stones.

Said purposes and advantages will appear to a greater extent by the following description, relating to a preferred embodiment of “tennis” type wearable jewel and a preferred applicative embodiment of the process, both object of the invention, given by indicative and illustrative, but not limited, way with the help of the attached tables of drawing in which:

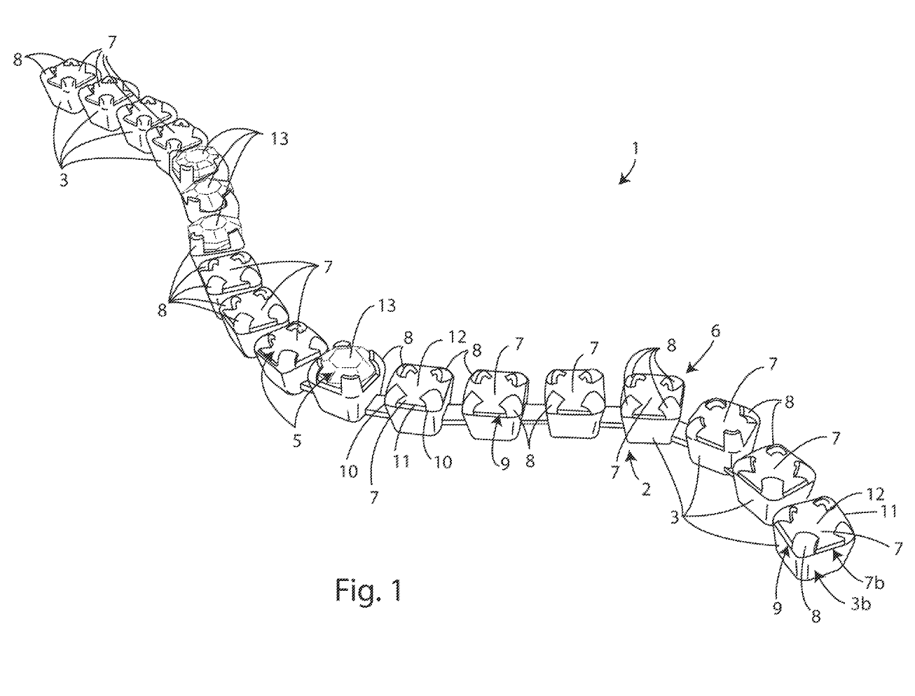

FIG. 1 is an assonometric view of the “tennis” type wearable jewel of the invention;

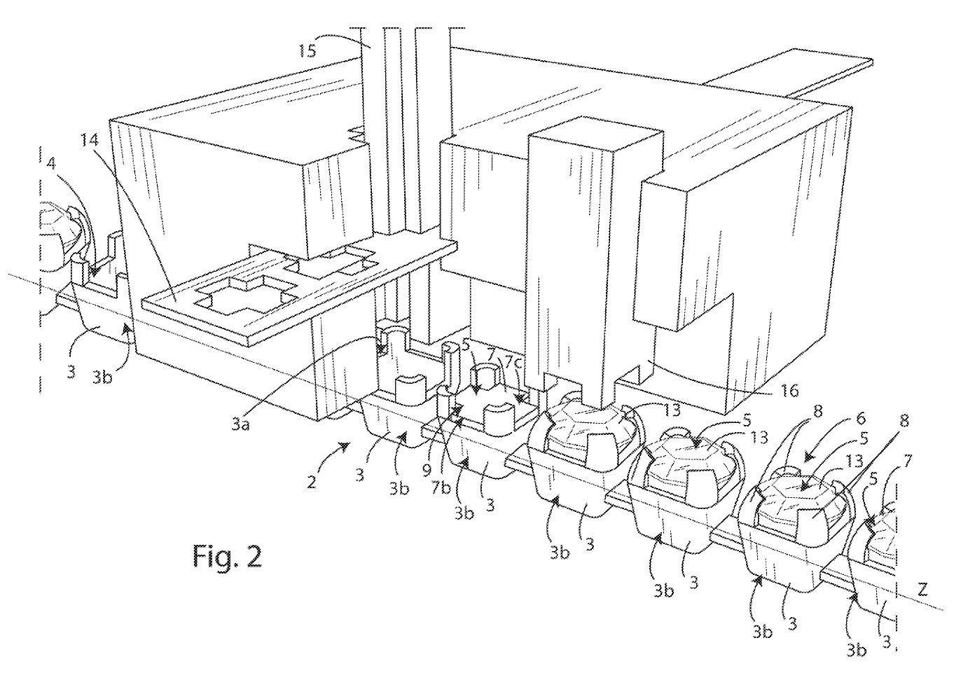

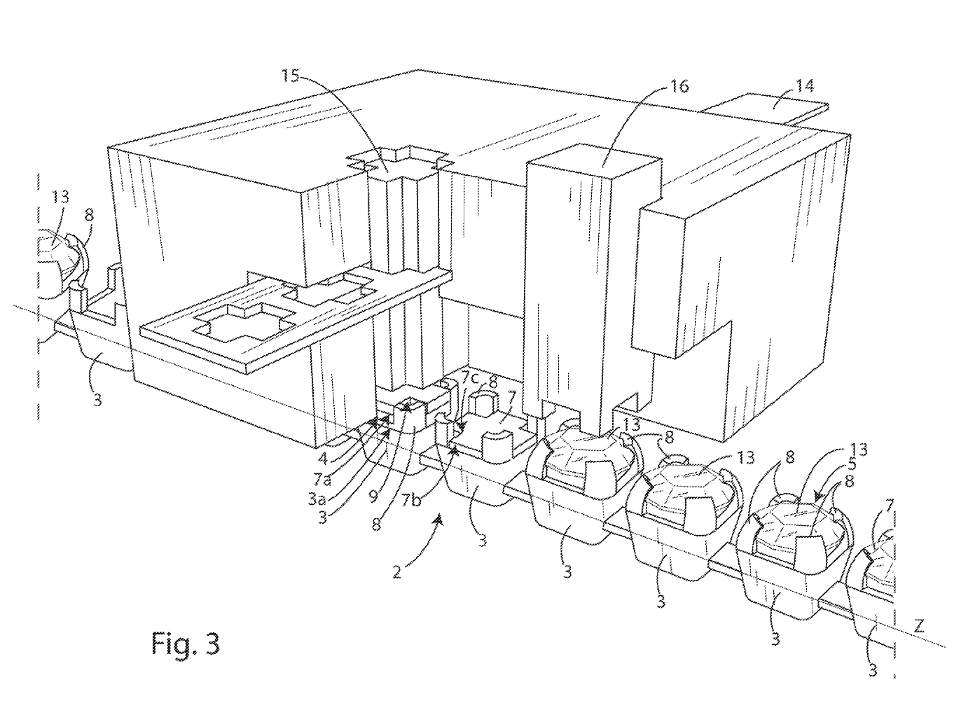

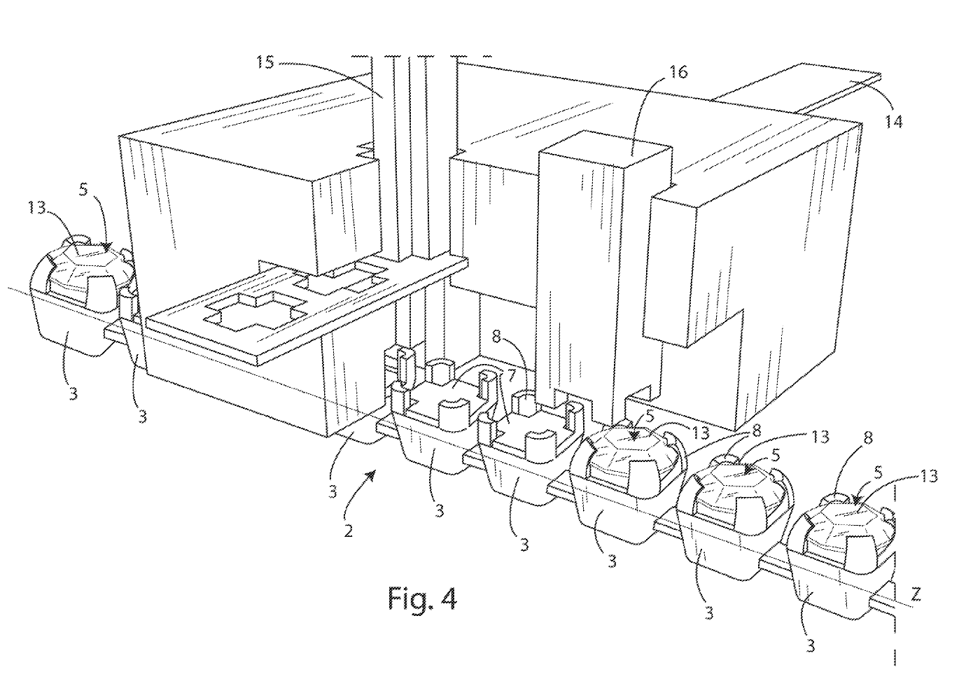

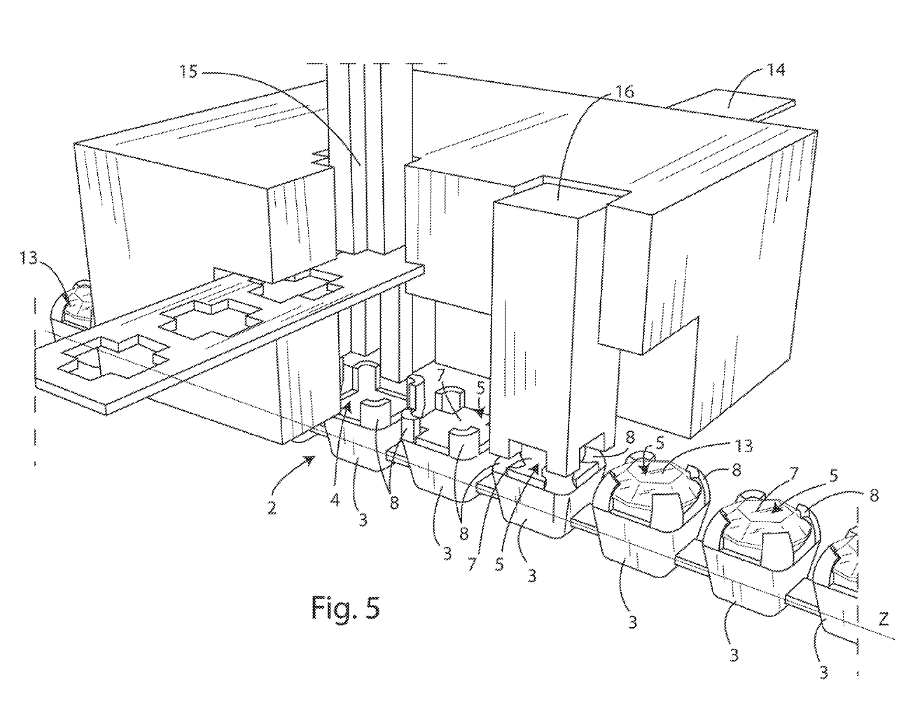

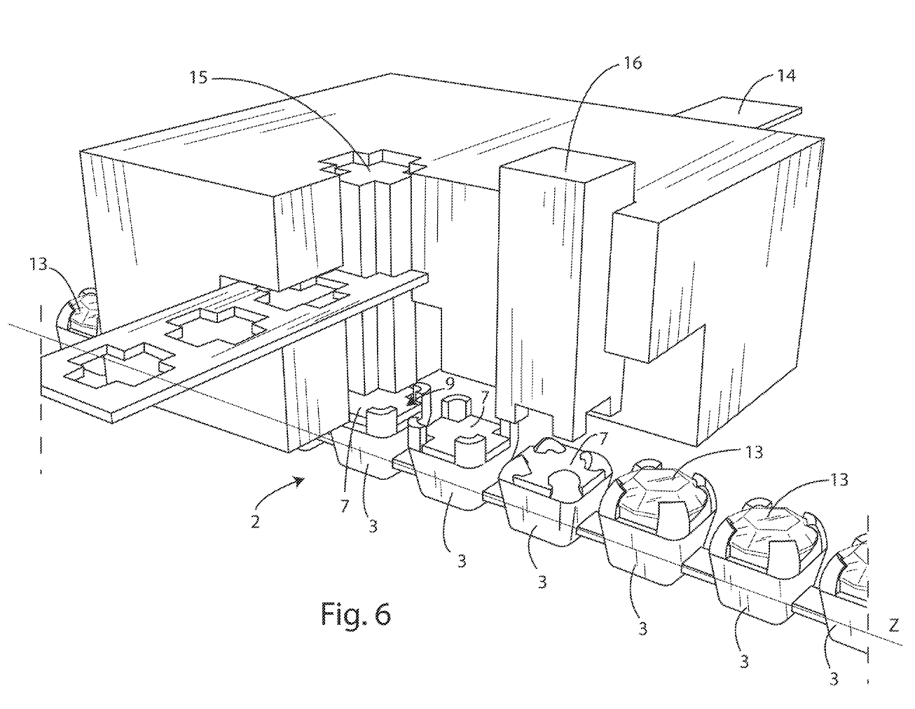

FIGS. 2-6 are schematic and simplified assonometric views of different and consecutive phases of the process of the invention for producing the wearable jewel of FIG. 1.

The “tennis” type wearable jewel of the invention is illustrated in the final configuration in FIG. 1, where it is globally indicated with 1.

In this case, purely by way of example, the wearable jewel 1 is represented by a bracelet devoid of closure, but it is understood that in other solutions, not shown, the wearable jewel of the invention could consists of a necklace, chain, anklet, earring, ring or other goldsmith, jewellery and/or trinkets items.

As it can be observed, the wearable jewel 1 comprises:
a base piece 2, for example flexible, made of metallic material and composed of a plurality of shaped bezels 3 connected and side by side each, each of which presents a housing seat 4 facing outwards;
a plurality of ornamental elements 5 remaining in sight, each of which firmly coupled through retention means, overall numbered with 6, with one of the shaped bezels 3 at the housing seat 4.

According to the invention, in this case some of the ornamental elements 5 comprise a laminar plate 7 made of metallic material, arranged at full cover of the housing seat 4 defined in each of the shaped bezels 3. In a preferred but non-binding manner, the metallic material is any one of the precious metals selected from the group consisting of gold, silver, platinum and palladium, in their various possible colours.

Similarly, but at purely preferential title, even the metallic material of each of the shaped bezels 3 of the flexible base piece 2 is any of the precious metals selected from the group consisting of gold, silver, platinum and palladium.

It is immediately stated precisely that every shaped bezel 3 with which the laminar plate 7 is not coupled comprises in this case, in preferred though not binding way, a stone 13, for instance a diamond.

The lower face 7a of the laminar plate 7 is facing towards the housing seat 4 of the shaped bezels 3 concerned and, in this case, is placed for the entire peripheral section close to the perimetric edge 3a delimiting the housing seat 4 of the shaped bezels 3. Advantageously, the laminar plate 7 is contained in the overall dimensions defined by each of the shaped bezels 3 with which is firmly coupled, being provided with an outer edge 7b substantially coplanar with the outer wall 3b of each of these shaped bezels 3.

This ensures linearity and harmony of form to the aesthetic effect related to the “tennis” type wearable jewel 1 of the invention, whose component shaped bezels 3 are substantially devoid of projections.

The laminar plate 7 presents a profile which in this case is totally conjugated with the profile of the perimetric edge 3a delimiting the housing seat 4 of each of the shaped bezels 3.

However, in other embodiments of the invention, not accompanied herewith by reference drawings, the profile of the laminar plate could conjugate only partially but congenially with the profile of the perimetric edge delimiting the housing seat of the shaped bezels, without this negatively affects the coupling effectiveness and aesthetic effect quality of the wearable jewel.

Moreover, just such an aspect allows to achieve one of the purposes of the invention, i.e. the possibility to vary the aesthetic effect of a “tennis” type wearable jewel without having to completely replace all of its components but exploiting a single flexible base piece. Preferably but not necessarily, the laminar plate 7 presents a thickness of value in the range 0.05÷1 mm (usually 0.2 mm), range of values that assures from one side the possibility to properly and effectively work and apply the laminar plate 7 to the various shaped bezels 3 concerned, avoiding breakages, on the other side a proper weight of the finished product, especially in relation to its final price whereas the laminar plate 7 is made of precious metal.

According to the preferred embodiment herein described of the wearable jewel 1 of the invention, the retention means 6 include a plurality of folding jaws 8, monolithic with each of the shaped bezels 3 and protruding upwardly from the shaped bezels 3 themselves, placed at least partially close to the upper face 7c of laminar plate 7.

More in detail, the folding jaws 8 protrude from the perimetric edge 3a of the shaped bezels 3 over which are uniformly distributed.

FIG. 1 highlights that the laminar plate 7 presents a plurality of perimetrical recesses 9, in each of which a base portion 10 of one of the folding jaws 8 is received, and a plurality of as many protruding teeth 11, coplanar to the central portion 12 of the laminar plate 7.

Each of the protruding teeth 11 is thus interposed between two folding jaws 8 adjacent each other.

As already mentioned, object of the present invention is also the process for producing “tennis” type wearable jewel, shown schematically in FIGS. 2-6.

The process comprises the operation of preparing the base piece 2 made of metallic material and a plurality of shaped bezels 3 connected and side by side each other, each of which presenting a housing seat 4 facing outwards.

The process of the invention, then, includes the operation of firmly coupling a plurality of ornamental elements 5 with the shaped bezels 3 at the housing seat 4 so that the ornamental elements 5 remain in sight.

In accordance with the invention, a phase of the operation of coupling the ornamental elements 5 with the shaped bezels 3 consists in conveying as ornamental element a laminar plate 7 made of metallic material close to the perimetric edge 3a of some of the shaped bezels 3 placing it at covering of the housing seat 4. The laminar plate 7 is obtained through an operation of punching, or shearing, a continuous laminar tape 14, performed through a shaping punch 15 before the operation of conveying the laminar plate 7 close to the perimetric edge 3a of the shaped bezels 3 concerned. The operation of conveying the laminar plate 7 close to the perimetric edge 3a of the shaped bezels 3 is performed by the shaping punch 15, without interruption with respect to the operation of punching the laminar tape 14.

The shaping punch, indeed, after having made the laminar plate 7, continues its vertical stroke and drag the laminar plate 7 itself towards the housing seat 4 of the shaped bezels 3 of the base piece 2 below.

The operation of dragging the laminar plate 7 is stopped when the peripheral section, in this case complete, of the lower face 7a of the laminar plate 7 interferes with the perimetric edge 3a delimiting the housing seat 4 of the shaped bezels 3.

According to the preferred applicative embodiment here described of the process of the invention, the operation of firmly coupling the ornamental elements 5 with the shaped bezels 3 consists in bending the plurality of folding jaws 8 close to the upper face 7c, 13c respectively of the laminar plate 7 and stones 13 which represent the ornamental elements 5 in this case. Bending of the folding jaws 8 occurs preferably by means of a pressing tool 16 placed above the base piece 2 and downstream the shaping punch 15.

Advantageously, the process of the invention includes the operation of moving the base piece 2 along a longitudinal direction Z, performed after the operation of conveying the laminar plate 7 towards the corresponding shaped bezel 3 and before bending the folding jaws 8 close to the upper face 7c of the laminar plate 7 in order to firmly couple it with such a shaped bezel 3.

This also occurs for those shaped bezels 3 of the base piece 2 which receive a stone 13 in the housing seat 4. On the basis on the foregoing, it is, therefore, understood that the “tennis” type wearable jewel and process for producing such a wearable jewel, both object of the invention, reach the purposes and achieve the advantages mentioned above.

In execution phase, changes could be made to “tennis” type wearable jewel of the invention consisting in, for instance, retention means which differ from those ones described above and illustrated in the drawings that follow, for example a bead of welding.

In addition, other embodiments of the wearable jewel of the invention, not shown, could provide that the base piece is formed by a different number of shaped bezels, this number could vary depending on the needs starting from one; it is clear that the number of ornamental elements will vary accordingly.

In further embodiments, yet not shown, the “tennis” type wearable jewel here claimed could include a series of base pieces, properly connected each other, which does not affect the advantages brought by the present invention.

Moreover, in other embodiments of the invention, not shown, all the ornamental elements or some of them in number different from that one shown in the attached figures could include a laminar plate made of metallic material.

Other embodiments of the invention, always not represented in the attached drawings, could also exist in which the laminar plate covers only partly the housing seat of one or more of the shaped bezels of the base piece.

Finally, the number of shaped bezels that make up the base piece could be different from that one that can be seen in the figures here attached, this number could vary at will depending on the type of wearable jewel of “tennis” type to be manufactured.

It is noted that although the above description has been exclusively directed to wearable jewels of “tennis” type in which the ornamental elements are coupled with only one side of the base piece, the inventive concept expressed by the invention also extends to so-called “double-face” wearable jewels of “tennis” type, where the ornamental elements (laminar plates and stones) are applied to both sides opposite each other of the base piece.

It is, finally, clear that many other variations may be made to the “tennis” type wearable jewel and process in exam, without departing from the principle of novelty intrinsic in the inventive idea expressed here, as it is clear that, in the practical implementation of the invention, materials, shapes and sizes of the illustrated details can be changed, as needed, and replaced with others technically equivalent.

Where the constructive features and techniques mentioned in the following claims are followed by reference numbers or signs, those reference signs have been introduced with the sole objective of increasing the intelligibility of the claims themselves and therefore they have no limiting effect on the interpretation of each element identified, by way of example only, by these reference signs.

1. “Tennis” type wearable jewel (1) comprising:
at least one base piece (2) made of metallic material and composed of one or more shaped bezels (3), each of which presents a housing seat (4) facing outwards;
one or more ornamental elements (5) remaining in sight, each of which firmly coupled with retention means (6) with one of said shaped bezels (3) at said housing seat (4),
characterized in that at least one of said ornamental elements comprises a laminar plate (7) made of metallic material, covering at least partially said housing seat (4) defined in each of said shaped bezels (3).

2. Jewel (1) as claim 1) characterized in that said metallic material is any one of the precious metals selected from the group consisting of gold, silver, platinum and palladium.

3. Jewel (1) as claim 1) or 2) characterized in that the lower face (7a) of said laminar plate (7) is facing towards said housing seat (4) of said shaped bezels (3) and is positioned for at least a peripheral section close to the perimetric edge (3a) delimiting said housing seat (4) of said shaped bezels (3).

4. Jewel (1) as any of the previous claims characterized in that said laminar plate (7) is contained in the overall dimensions defined by each of said shaped bezels (3) with which is firmly coupled, being provided with an outer edge (7b) substantially coplanar with the outer wall (3b) of each of said shaped bezels (3) with which is coupled.

5. Jewel (1) as any of the previous claims characterized in that said laminar plate (7) presents a thickness of value in the range 0.05÷1 mm.

6. Jewel (1) as any of the previous claims characterized in that said retention means (6) include a plurality of folding jaws (8), monolithic to each of said shaped bezels (3) and protruding upwardly from said shaped bezels (3), placed at least partially close to the upper face (7c) of said laminar plate (7).

7. Jewel (1) as claim 6) characterized in that said folding jaws (8) protrude from said perimetric edge (3a) of said shaped bezels (3) and are uniformly distributed over said perimetric edge (3a).

8. Jewel (1) as claim 6) or 7) characterized in that said laminar plate (7) presents a plurality of perimetrical recesses (9), in each of which a base portion (10) of one of said folding jaws (8) is received, and a plurality of as many protruding teeth (11), coplanar to the central portion (12) of said laminar plate (7), each of which interposed between two of said folding jaws (8) adjacent each other.

9. Process for the production of a “tennis” type wearable jewel (1) comprising the following steps:
preparing at least one base piece (2) made of metallic material and composed of one or more shaped bezels (3), each of which presents a housing seat (4) facing outwards;
firmly coupling one or more ornamental elements (5) with said shaped bezels (3) at said housing seat (4) in such a way as said ornamental elements (5) remain in sight,
characterized in that at least one phase of said operation of coupling said ornamental elements (5) with said shaped bezels (3) consists in conveying a laminar plate (7) made of metallic material close to the perimetric edge (3a) of at least one of said shaped bezels (3) placing it at partial covering of said housing seat (4).

10. Process as claim 9) characterized in that said laminar plate (7) is obtained through an operation of punching a continuous laminar tape (14), performed through a shaping punch (15) before said operation of conveying said laminar plate (7) close to said perimetric edge (3a) of at least one of said shaped bezels (3).

11. Process as claim 10) characterized in that said operation of conveying said laminar plate (7) close to said perimetric edge (3a) of at least one of said shaped bezels (3) is performed by said shaping punch (15), without interruption with respect to said punching operation of said laminar tape (14), which drags said laminar plate (7) towards said housing seat (4) of said shaped bezels (3) of said base piece (2) placed below said shaping punch (15).

12. Process as claim 11) characterized in that said operation of dragging said plate laminar (7) is stopped when at least a peripheral section of the lower face (7a) of said laminar plate (7) interferes with the perimetric edge (3a) delimiting said housing seat (4) of said shaped bezels (3).

13. Process as any of the claims from 10) to 12) characterized in that said operation of firmly coupling said ornamental elements (5) with said shaped bezels (3) consists in bending a plurality of folding jaws (8) close to the upper face (7c, 13c) of said ornamental elements (5), performed by a pressing tool (16) provided above said base piece (2) and downstream said shaping punch (15).

14. Process as claim 13) characterized in that it comprises the operation of moving said base piece (2) along a longitudinal direction (Z), performed after said operation of conveying said laminar plate (7) towards at least one of said shaped bezels (3) and before said operation of folding said folding jaw (8) close to said upper face (7c) of said laminar plate (7) in order to firmly couple it with at least one of said shaped bezels (3).
